(19) United States
(12) Patent Application Publication
(10) Pub. No.: US 2026/0239520 A1
(43) Pub. Date: Aug. 13, 2026

(54) X-ray analysis system with laser-driven source

(71) Applicant: BRUKER TECHNOLOGIES LTD., Migdal HaEmek (IL)

(72) Inventors: Matthew Wormington, Highlands Ranch, CO (US); Roger Durst, Ettlingen (DE); Alexander Krokhmal, Haifa (IL); Christoph Ollinger, Karlsruhe (DE)

(21) Appl. No.: 19/161,250

(22) PCT Filed: Mar. 25, 2024
(86) PCT No.: PCT/IB2024/052835

§ 371 Date: Aug. 31, 2025

Related U.S. Application Data
(60) Provisional application No. 63/493,020, filed on Mar. 30, 2023.

(51) Int. Cl. H05G 2/00; G01N 23/20008

(52) U.S. Cl. CPC H05G 2/0082; G01N 23/20008; H05G 2/0035; H05G 2/0092; G01N 2223/204; G01N 2223/317

(57) ABSTRACT

A system (10, 11) for X-ray analysis, the system includes an X-ray enclosure (55) and a window assembly (66a, 66b, 66c, 66d). The X-ray enclosure is configured to (a) contain an X-ray source (XRS) (44) configured to emit one or more X-ray beams (12) in response to a laser beam (33) impinging on a surface of the XRS, and (b) prevent emission of the one or more X-ray beams from exiting the X-ray enclosure, the X-ray enclosure having a window (65) configured to pass the laser beam into the X-ray enclosure. The window assembly is coupled to the window, the window assembly is configured to: (i) bend and pass the laser beam into the X-ray enclosure, and (ii) block the emission of the one or more X-ray beams (12, 16, 20) from exiting the X-ray enclosure.

### CROSS-REFERENCE TO RELATED APPLICATIONS

This application claims the benefit of U.S. Provisional Patent Application 63/493,020, filed Mar. 30, 2023, whose disclosure is incorporated herein by reference.

### FIELD OF THE INVENTION

The present invention relates generally to X-ray analysis, and particularly to methods and systems for integrating an X-ray source into an X-ray system.

### BACKGROUND OF THE INVENTION

X-ray technology is used in research, development, optimization, and production of various types of materials and structures across various industries and products.

Different applications of X-rays require different properties of X-ray beams, such as but not limited to energy, power, spot size, flux, uniformity across the spot, and brightness (also referred to herein as brilliance). The X-ray beams are optimized to address the respective application requirements based on tradeoffs and optimizations of these properties.

Some techniques use liquid metal-based source of X-rays. For example, U.S. Pat. No. 7,929,667 described an X-ray metrology tool having a liquid metal-based X-ray source for increasing the brightness of the X-rays emitted from the source.

U.S. Patent Application Publication 2018/0206319 described a laser-produced plasma X-ray system including a liquid metal flow system enclosed within a low-pressure chamber.

### SUMMARY OF THE INVENTION

An embodiment of the present invention that is described herein provides a system for X-ray analysis, the system includes an X-ray enclosure and a window assembly. The X-ray enclosure is configured to (a) contain an X-ray source (XRS) configured to emit one or more X-ray beams in response to a laser beam impinging on a surface of the XRS, and (b) prevent emission of the one or more X-ray beams from exiting the X-ray enclosure, the X-ray enclosure having a window configured to pass the laser beam into the X-ray enclosure. The window assembly is coupled to the window, the window assembly is configured to: (i) bend and pass the laser beam into the X-ray enclosure, and (ii) block the emission of the one or more X-ray beams from exiting the X-ray enclosure.

In some embodiments, the window assembly includes (i) an X-ray blocking labyrinth, and (ii) one or more mirrors positioned in the labyrinth and configured to bend the laser beam one or more times, respectively. In other embodiments, the window assembly includes (i) an X-ray blocking labyrinth, and (ii) one or more prisms positioned in the labyrinth and configured to bend the laser beam one or more times, respectively. In yet other embodiments, the X-ray enclosure is configured to operate at a pressure larger than 10⁻³ torr.

In some embodiments, the X-ray enclosure is configured to operate at an atmospheric pressure. In other embodiments, the XRS includes liquid metal, and the one or more X-ray beams are emitted in response to the laser beam impinging on the liquid metal. In yet other embodiments, the XRS includes a target selected from a list of targets constituting at least one of (i) a continuous solid metal wire, (ii) a strip of solid metal, (iii) droplets of liquid metal, (iv) a jet of continuous liquid metal, (v) a rotating drum coated with liquid metal, and (vi) a rotating disk coated with liquid metal, and the one or more X-ray beams are emitted in response to the laser beam impinging on the target.

In some embodiments, the laser beam is generated by a laser source positioned out of the X-ray enclosure. In other embodiments, the one or more X-ray beams include pulses of X-ray beams. In yet other embodiments, the pulses of X-ray beams have a frequency between 1 KHz and 100 MHz's.

There is additionally provided, in accordance with an embodiment of the present invention, a method including receiving a laser beam directed toward a window of an X-ray enclosure. the laser beam is bent in a window assembly coupled to the window, and the laser beam is directed through the window toward an X-ray source (XRS) disposed within the X-ray enclosure. One or more X-ray beams are emitted by impinging the laser beam on the XRS, and the emission of the one or more X-ray beams is blocked from exiting the X-ray enclosure.

In some embodiments, receiving the laser beam includes generating the laser beam in a laser source positioned out of the X-ray enclosure, and directing the laser beam toward the window, and emitting the one or more X-ray beams includes emitting pulses of the one or more X-ray beams.

There is further provided, in accordance with an embodiment of the present invention, a method for producing an X-ray analysis system, the method including disposing, in an X-ray enclosure having a window, (i) an X-ray source (XRS) for generating one or more X-ray beams, (ii) a detector assembly for generating a signal in response to the one or more X-ray beams impinging on a sample and subsequently impinging on the detector assembly, and (iii) X-ray optics for directing the one or more X-ray beams (a) from the XRS toward the sample, and (b) from the sample toward the detector assembly. A laser source is disposed out of the X-ray enclosure for directing a laser beam through the window toward the XRS. A window assembly is coupled to the window of the X-ray enclosure, the window assembly has (i) an X-ray blocking labyrinth, and (ii) one or more optical elements positioned in the labyrinth for (a) bending the laser beam one or more times within the X-ray blocking labyrinth, respectively, and (b) directing the laser beam through the window toward the XRS for generating the one or more X-ray beams.

In some embodiments, the one or more optical elements for bending and directing the laser beam includes at least one of: (i) a mirror for reflecting the laser beam, and (ii) a prism for refracting the laser beam. In other embodiments, the X-ray enclosure is opaque to the one or more X-ray beams, and the window is for passing the laser beam into the X-ray enclosure. In yet other embodiments, disposing the XRS includes disposing the XRS having a liquid metal target for generating pulses of the one or more X-ray beams in response to the laser beam impinging on the liquid metal of the XRS.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a reflection geometry-based X-ray analysis system, in accordance with an embodiment of the present invention;

FIG. 2 is a block diagram that schematically illustrates a transmission geometry-based X-ray analysis system, in accordance with another embodiment of the present invention;

FIGS. 3, 4, 5, and 6 are sectional views of window assemblies that allow passage of a laser beam into the X-ray enclosures of FIGS. 1 and 2 above, in accordance with several embodiments of the present invention;

FIG. 7 is a flow chart that schematically illustrates a method for operating the X-ray analysis systems of FIGS. 1 and 2 above using at least one of the windows assemblies of FIGS. 3-6 above, in accordance with an embodiment of the present invention; and

FIG. 8 is a flow chart that schematically illustrates a method for producing the X-ray analysis systems of FIGS. 1 and 2 above, in accordance with an embodiment of the present invention.

### DETAILED DESCRIPTION OF EMBODIMENTS

### Overview

Embodiment of the present invention that is described herein provide X-ray analysis systems comprising (i) an X-ray source assembly (XRS) configured to generate X-ray beams, the structure and properties of the XRS are described below, (ii) a laser assembly configured to direct a laser beam toward the XRS for generating the X-ray beams, (iii) source optics configured to direct the X-ray beams toward a sample in question, (iv) a detector assembly comprising one or more detectors configured to detect X-ray beam exiting from the sample, and (v) detector optics configured to direct the X-ray beams from the sample toward the detector assembly. The X-ray analysis systems may have (i) a reflection geometry in which the incident X-ray beams are reflected from the sample, and subsequently, are directed by the detector optics toward the detector assembly, or (ii) a transmission geometry in which the incident X-ray beams are transmitted (e.g., scattered) through the sample, and subsequently, are directed by the detector optics toward the detector assembly.

In some embodiments, the X-ray beams generated by the XRS comprise pulsed X-ray beams. In the present example, the pulse rate of the generated X-ray beams has a frequency range between about one kHz and several (e.g., about 100) MHz's. Moreover, the pulsed nature of the generated X-ray beams has instantaneous power that can be substantially larger than an average power of a continuous (i.e., not pulsed) X-ray beam generated in electron beam driven X-ray sources.

In some embodiments the X-ray analysis systems comprise an X-ray safety enclosure, also referred to herein as an X-ray enclosure, which is configured to (a) contain the XRS configured to emit the X-ray beams in response to the laser beam impinging on a surface of the XRS, and (b) prevent emission of the X-ray beams from exiting the X-ray enclosure. The X-ray enclosure having a window configured to pass the laser beam into the X-ray enclosure. In the present example, in order to provide users with X-ray safety, the X-ray enclosure is further configured to contain the source optics, the detector optics, the sample, and the detector assembly.

In some embodiments, the laser assembly comprises a laser source configured to generate the aforementioned laser beam. It is noted, however, that in the present example configuration, at least the laser source is positioned out of the X-ray enclosure.

In some embodiments the X-ray analysis systems further comprise a window assembly, which is coupled to (e.g., assembled to or produced together with) the window of the X-ray enclosure. The window assembly is configured to: (i) bend and pass the laser beam into the X-ray enclosure, and (ii) block the emission of the one or more X-ray beams from exiting the X-ray enclosure.

In some embodiments the window assembly comprises an X-ray blocking labyrinth. In the context of the present disclosure and in the claims, the term “labyrinth” refers to an arrangement of walls and/or compartments that are made of X-ray opaque (or partially opaque) material, and encompass one or more optical elements, such as but not limited to one or more laser reflecting and/or refracting elements described below. The labyrinth is configured to absorb any X-ray radiation that passes through the window of the X-ray enclosure, and at the same time not to obstruct the path of the laser beam.

In some embodiments, the reflecting and/or refracting elements may comprise one or more mirrors and/or one or more prisms that are positioned in the labyrinth and are configured to bend the laser beam one or more times, respectively.

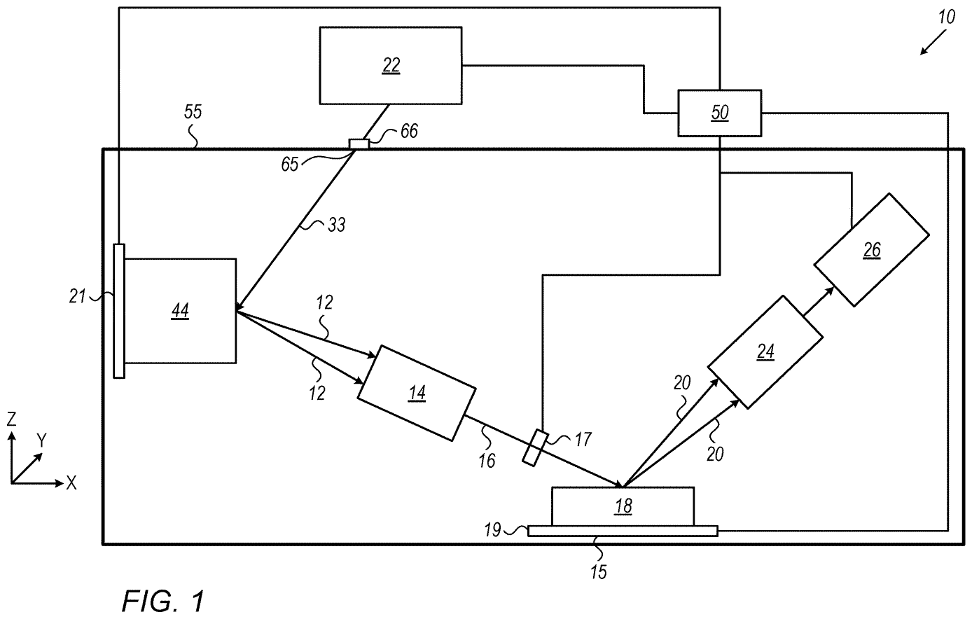

In some embodiments, the XRS is configured to operate in a high vacuum or ultra-high vacuum, for example, at a pressure between about 10⁻⁵ torr and 10⁻¹³ torr (e.g., a pressure smaller than about 10⁻⁷ torr). In the present example, the XRS comprises a liquid metal target for improving the brightness and other properties of the X-ray beams. In accordance with the above description, the X-ray beams are emitted from the XRS in response to the laser beam impinging on the liquid metal target. Several configurations of the liquid metal target and XRS, as well as additional components and assemblies of the X-ray system (e.g., the aforementioned optics and detectors, and movement stages), are described in detail in FIGS. 1-6 below.

In some embodiments, the X-ray enclosure is configured to operate at a pressure larger than 10⁻³ torr, but in other embodiments, the X-ray enclosure is configured to operate at an atmospheric pressure, as will be depicted in detail below.

The disclosed techniques improve the functionality and safety of X-ray systems. For example, the disclosed techniques improve the integration of a liquid-metal based X-ray source into an X-ray analysis system operating in various facilities, such as research, development, and high-volume manufacturing (HMV) facilities. Based on the disclosed techniques, the laser assembly could be positioned in a different room (such as in a sub-fab area of a semiconductor manufacturing facility) or in a rack outside of the X-ray enclosure.

### System Description

FIG. 1 is a block diagram that schematically illustrates a reflection geometry-based X-ray analysis system 10, in accordance with an embodiment of the present invention. The reflection geometry-based X-ray analysis system 10 is also referred to herein as a system 10, for brevity.

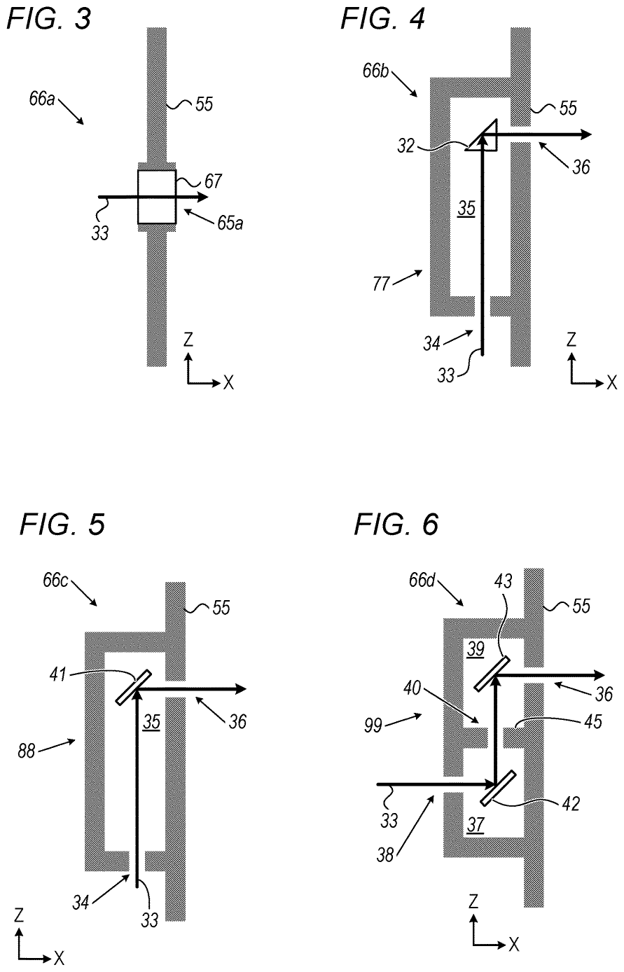

In some embodiments, system 10 comprises a laser source 22, which is implemented in a laser assembly (not shown) having additional components, such as (but not limited to) control hardware and laser driving circuitry, laser optics and housing of the laser assembly. In the context of the present disclosure and in the claims, the term laser source refers to a laser-driven X-ray source, as will be described in detail below. Laser source 22 is configured to emit one or more laser beams, referred to herein as a beam 33, directed by the laser optics through a window assembly 66 into an X-ray safety enclosure 55. In some embodiments, the laser beam could have any suitable wavelength between ultraviolet and infrared, e.g., between about 100 nm and at least 2000 nm. Embodiments and configurations of window assembly 66 are described in detail in FIGS. 3, 4, 5 and 6 below, and X-ray safety enclosure 55 is described herein.

In some embodiments, in addition to laser source 22, system 10 comprises (i) one or more X-ray source assemblies (XRSs) 44 configured to generate pulsed X-ray beams 12 as will be described below, (ii) source optics 14 configured to receive X-ray beams 12 and focus them as incident beams 16 directed to impinge on a sample 18 mounted on a stage 19 (the properties of sample 18 and stage 19 are described in detail below), (iii) a beam monitor 17 positioned along the optical path of incident beams 16, and configured to monitor the properties of beams 16 before impinging on the surface of sample 18, (iv) a detector assembly 26 comprising one or more detectors (e.g., two-dimensional photon counting detectors or charge integrating detectors) configured to produce a signal in response to detecting an X-ray beam 20 scattered from sample 18, (v) detector optics 24 configured to direct X-ray beams 20 from sample 18 toward detector assembly 26, and (vi) a processor 50, which is configured to: (a) receive the signal from detector assembly 26, and (b) control the components and assemblies of system 10, as will be described in detail below.

In the present configuration, processor 50 comprises any suitable type of a central processing unit (CPU), or a graphical processing unit (GPU), or a tensor processing unit (TPU) or any other suitable type of an application-specific integrated circuit (ASIC), which is implemented in a general-purpose computer programmed in software to carry out the functions described herein. The software may be downloaded to the computer in electronic form, over a network, for example, or it may, alternatively or additionally, be provided and/or stored on non-transitory tangible media, such as magnetic, optical, or electronic memory.

In some embodiments, X-ray safety enclosure 55 that in the present disclosure and in the claims is also referred to herein as X-ray enclosure (55) or enclosure 55 (for brevity), is configured to contain all the aforementioned components and assemblies, but laser source 22. Moreover, for the safety of the users of system 10, X-ray safety enclosure 55 is configured to prevent emission of the X-ray beams (e.g., beams 12, 16, and 20) from exiting X-ray enclosure 55.

In some embodiments, X-ray safety enclosure 55 is configured to operate either at an atmospheric pressure, or in low levels of vacuum, for example, at a pressure larger than about 10⁻³ torr. In an embodiments, X-ray enclosure 55 has a window 65, which is configured to pass laser beam 33 into X-ray enclosure 55, and to retain the intended pressure within X-ray enclosure 55. As such, in case the X-ray analysis application requires sub-atmospheric pressure (e.g., the aforementioned low level of vacuum), window 65 is configured to seal X-ray enclosure 55, and thereby, maintain the required level of vacuum (e.g., larger than about 10⁻³ torr but smaller than atmospheric pressure).

In some embodiments, the one or more XRSs 44 are mounted on a stage 21, whose features are described below. Each XRS 44 has an X-ray source head, which comprises a liquid metal target. In some embodiments, in response to beam 33 impinging on the liquid metal target, XRS 44 is configured to generate one or more X-ray beams, referred to herein as beams 12.

In some embodiments, X-ray beams 12 comprise pulsed X-ray beams. In the present example, the pulse rate of X-ray beams 12 has a frequency range between about one kHz and several (e.g., about 100) MHz's. Moreover, the pulsed nature of X-ray beams 12 has instantaneous power that can be substantially larger than an average power of a continuous X-ray beam generated in electron beam driven X-ray sources, in which an electron beam is directed to impinge on a solid target.

In some embodiments, XRS 44 is configured to operate in ultra-high vacuum, for example, at a pressure between about 10⁻⁵ torr and 10⁻¹³ torr. In some embodiments, the liquid metal target may be generated in the X-ray source head using a suitable configuration selected from a list of several configurations, such as but not limited to (i) a target of a continuous jet of liquid metal, (ii) a rotating drum liquid metal target, and (iii) a rotating disk liquid metal target.

In some embodiments, XRS 44 having the liquid metal jet target comprises a liquid metal reservoir, a pump, and a nozzle. While being operated, the pump draws the liquid metal from the reservoir into the nozzle, which is configured to jet droplets of the liquid metal toward the reservoir. In this configuration, laser beam 33 is directed from laser source 22 to impinge on the liquid metal droplets or continuous flowing liquid metal target (jet) for generating beams 12. It is noted that the jet of liquid metal may comprise separate droplets or a continuous jet of liquid metal. The arrangement of the liquid (e.g., separate droplets, or continuous jet) may affect the properties (e.g., frequency) of X-rays generated in response to the laser beam impinging on the liquid metal.

In some embodiments, XRS 44 having the rotating drum liquid metal target comprises a liquid metal reservoir, and a rotating drum that is partially immersed in the liquid metal. While being operated, the outer surface of the drum is immersed, and is wetted with the liquid metal, and while being rotated, the liquid metal remaining on the surface is pulled out of the reservoir and facing beam 33. In this configuration, laser beam 33 is directed from laser source 22 to impinge on the liquid metal wetting the drum surface for generating beams 12.

In some embodiments, XRS 44 having the rotating disk liquid metal target comprises a disk having one or more compartments, each of which containing liquid metal and having an opening. While being operated, when the disk rotates, a centrifugal force is applied to the liquid metal. In response to the centrifugal force the liquid metal accumulates in each compartment, at a corner that is facing laser beam 33. In this configuration, laser beam 33 is directed from laser source 22 to impinge on the liquid metal at the corner(s) to generating beams 12 that are emitted through the respective opening(s).

It is noted that the liquid metal jet target, rotating drum liquid metal target, and rotating disk liquid metal target are example implementations of liquid metal targets. In other embodiments, XRS 44 may be implemented using any other configuration suitable for generating X-rays 12 having properties (e.g., brightness, flux, and energy) required for a respective X-ray analysis application. In the present example, energy of the X-ray beams may have a range between soft X-rays and hard X-rays, for example, with energies between about 0.2 keV and a few 10 s of keV. It is noted that these energies are higher than the energy used in extreme EUV applications, which are typically smaller than about 150 eV.

In some embodiments, stage 21 is configured to move XRS 44 relative to beam 33, so as to improve the generation of beams 12 as described above. In one implementation, stage 21 is configured to move at least along a Z-axis of an XYZ coordinate system, and system 10 comprises at least two XRSs 44 mounted side-by-side on stage 21. In this implementation, at least two of the XRS 44 may have different compositions of materials resulting in different properties of the X-ray beams 12 emitted from each XRS 44. The materials of the liquid metal targets may be selected from a list of metals having melting temperature smaller than about 300° C., such as gallium (about 30° C.), indium (about 156° C.), tin (about 232° C.), thallium (about 300° C.), bismuth (about 270° C.), and any suitable combinations thereof. Additionally, or alternatively, at least two of the XRS 44 may have any other difference from one another that may result in different properties of the X-ray beams 12 emitted therefrom.

In this implementation, system 10 may comprise first and second XRSs 44 (not shown) configured to generate X-ray beams 12 having first and second properties, respectively. In some embodiments, based on the requirements of the X-ray analysis application, processor 50 is configured to control stage 21 to move, e.g., along the Z-axis, so that beam 33 impinges on the liquid metal target of (i) the first XRS 44 in a first X-ray analysis application, and (ii) the second XRS 44 in a second X-ray analysis application.

In another implementation, system 10 may comprise a single XRS 44 having single X-ray source head, and a single laser assembly having a single laser source 22. In this implementation, XRS 44 is mounted on stage 31, which is a rotation and/or translation stage, and laser beam 33 is delivered within an articulated arm (not shown) having one or more elbows. This configuration allows XRS 44 to move while maintaining a constant interaction point of laser beam 33 on the liquid metal target. For example, using two different sets of mirrors allows two respective positions of the XRS 44 (e.g., rotated about a Y-axis of the XYZ coordinate system), and thereby enables the generation of two different laser beams 33, respectively.

Additionally, or alternatively, in some embodiments, system 10 may comprise two or more, e.g., first and second, laser sources 22 configured to generate first and second X-ray beams 33, respectively, which are intended to be directed one after the other to impinge on a single XRS 44. In this implementation, processor 50 is configured to (i) control the first laser source 22 to direct the first beam 33 toward XRS 44 to excite, and thereby, to increase the efficiency of XRS 44, and (ii) control the second laser source 22 to subsequently direct the second beam 33 toward XRS 44 for generating X-ray beams 12 having the required properties (e.g., higher brightness compared to beams 12 generated without having the first laser beams 33 impinging on XRS 44).

In other embodiments, processor 50 is configured to control a single XRS 44 to direct the first beam 33 and subsequently the second beam 33 in order to obtain the excitation effect of XRS 44, which is described in detail above.

In some embodiments, stage 19 comprises a motorized stage, e.g., an XYZχωφ stage or an XYZ stage, having a chuck 15 mounted thereon. It is noted that χωφ are rotation axes about the x-, y- and z-directions. Also, the one or more of the detectors of detector assembly 26 may be mounted on a rotation stage typically referred to as the 2theta axis. Stage 19 is controlled by processor 50 to move sample 18 in the XYZ coordinate system described above. More specifically, processor 50 is configured to control stage 19 to move: (i) along the X- and Y-axes in order to perform X-ray analysis at predefined measurement sites on sample 18, and (ii) along the Z-axis in order to focus incident beam 16, e.g., on the outer surface of sample 18.

In some embodiments, stage 21 may comprise a rotation stage configured to rotate XRS 44 about the Y-axis. In such embodiments, processor 50 is configured to: (i) control stage 21 to rotate about the Y-axis, and at the same time, (ii) control stage 19 to move along the Z-axis to maintain the focus of beam 16 on the surface of sample 18.

In some embodiments, in detector assembly 26 the number and type of detector(s) depend on the technique being used. Moreover, as described above, XRS 44 is configured to generate pulsed beams 12. In the present example, the pulse rate of beams 12 has a frequency range between several kHz's and several MHz's. Thus, the type of detectors in detector assembly 26 used for detecting beams 20 typically depends on the pulse rate because the instantaneous power of the pulses can be substantially larger than an average power of a continuous X-ray beam generated by directing electron beam to a solid target.

In such embodiments, for pulse rates having a frequency in the kHz range, the detectors of detector assembly 26 may comprise a charge integrating detector, such as the PHOTON III detector supplied by Bruker (40 Manning Rd, Billerica, MA 01821), or a suitable detector from the JUNGFRAU family of detectors supplied by PSI company (5232 Villigen-PSI, Switzerland) for free-electron lasers.

In other embodiments, the detector(s) of detector assembly 26 may comprise two-dimensional (2D) photon counting detectors, such as Hybrid Pixel Array Detectors (HPAD), e.g., the Eiger series of products supplied by Dectris (Täfernweg 1, 5405 Baden, Switzerland). More specifically, Dectris' Eiger 2 product, which is designed for synchrotrons, is suitable for detecting X-ray beams 20 having a frequency in the range of several MHz's. Alternatively, the detectors may comprise (i) one-dimensional (1D) strip detectors, such as the LynxEye detectors supplied by Bruker, or the Mythen detectors supplied by Dectris, or (ii) any suitable type of solid-state drift detectors.

In some embodiments, sample 18 may comprise a wafer made from silicon or any other semiconductors from column IV of the periodic table of elements, e.g., germanium, or an alloy of silicon-germanium. Alternatively, sample 18 may comprise a wafer of compound semiconductors of elements from columns III and V, or from columns II and VI, or from column III and nitride or other materials. Moreover, sample 18 may comprise a wide variety of thin-film materials such as polymers, metals, metal alloys, and dielectric materials that are deposited on semiconductors to fabricate logic, memory, actuators, sensors, and other types of solid-state devices.

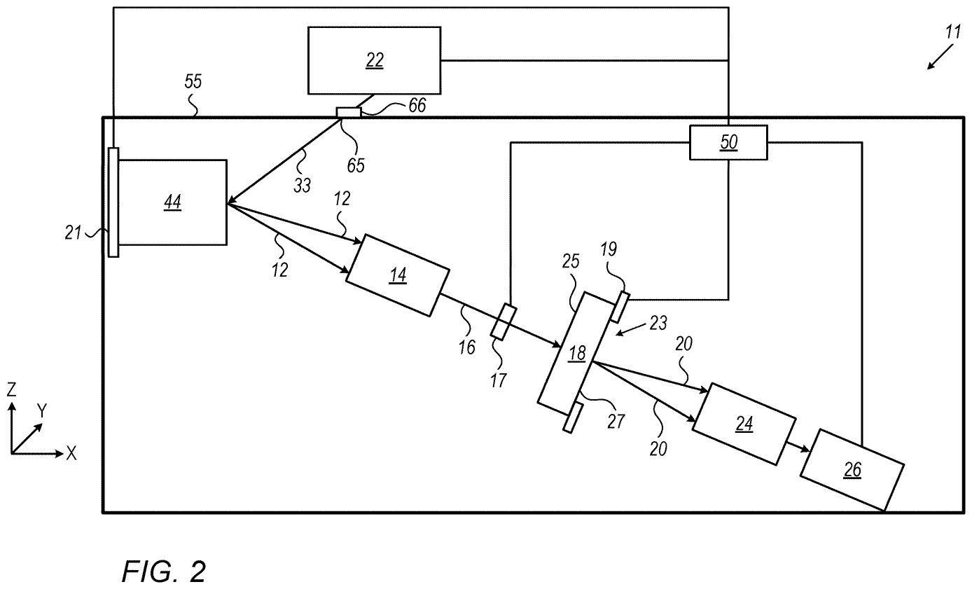

In other embodiments, sample 18 may comprise a component used in state-of-the-art battery and display products that require analysis by various X-ray techniques. In yet other embodiments, sample 18 may comprise biological and/or chemical molecules and mechanisms that require analysis using X-ray crystallography, at least some of these samples may be analyzed using the configuration of the system described in FIG. 2 below. Additionally, X-ray powder diffraction is used in many industrial areas, for example, the pharmaceutical and cement industries for quality control. These samples may also be analyzed using the configuration of the system described in FIG. 2 below.

Moreover, sample 18 may comprise any other sample that requires determination of micro stress and texture typically used in materials research applications, as well as in the automotive and aerospace industries.

In some embodiments, beam monitor 17 is configured to generate an additional signal indicative of the properties of incident beams 16. The additional signal may comprise intensity of a monochromatic beam or intensity at different X-ray energies for polychromatic beams and may be used to correct the analysis for changes in the properties of incident beams 16 over time. Moreover, processor 50 is configured to receive from an optical microscope and/or a camera (both not shown) signals indicative of images of measurement sites on sample 18. In some embodiments, based on the signals received from detector assembly 26 and/or from beam monitor 17 and/or from the optical microscope and/or a camera, processor 50 is configured to control the components and assemblies of system 10 that are described above. For example, based on these signals processor 50 is configured to control laser source 22 and/or XRS 44 to adjust operating parameters thereof in order to adjust the functionality and operation of system 10 in accordance with the requirements of any of the particular X-ray analysis applications described above. Moreover, based on the signals received from the optical microscope and/or a camera, processor 50 is configured to control stage 19 to move sample 18 in X-, Y-, and Z-axes.

In other embodiments, system 10 comprises multiple (e.g., two) source optics 14 (not shown). The plurality of source optics 14 serve as respective ports for a plurality of X-ray beams 12 emitted from a single XRS 44. In such embodiments, X-ray beams 12 emerging from the multiple ports may be associated with multiple source optics 14 (not shown) producing multiple incident beams 16 (not shown) with different characteristics or similar characteristics. In this configuration, beams 16 are directed by the multiple source optics 14, at respective different angles or positions toward sample 18. The scattered X-rays from sample 18 are directed by detector optics to be detected by the one or more detectors of detector assembly 26.

FIG. 2 is a block diagram that schematically illustrates a transmission geometry-based X-ray analysis system 11, in accordance with another embodiment of the present invention. The transmission geometry-based X-ray analysis system 11 is also referred to herein as a system 11, for brevity.

In some embodiments, stage 19 of system 11 has a chuck 23, which is designed as an open frame (i.e., having no material in the center) so as to allow incident beam 16 to impinge on a surface 25 of sample 18, and scatter through sample 18 and a surface 27 as beams 20 toward detector optics 24. It is noted that in system 11 XRS 44 and source optics 14 are facing a first side of sample 18, and detector optics 24 and detector assembly 26 are facing the opposite side of sample 18. Moreover, it is noted that (i) all other components and assemblies of system 10, and (ii) operational embodiments that have been described for system 10 in FIG. 1 above, are applicable, mutatis mutandis, to system 11.

These particular configurations of systems 10 and 11 are shown by way of example, in order to illustrate certain problems that are addressed by embodiments of the present invention and to demonstrate the application of these embodiments in enhancing the performance of such X-ray analysis systems. Embodiments of the present invention, however, are by no means limited to these specific sorts of X-ray analysis systems, and the principles described herein may similarly be applied to other sorts of X-ray analysis systems.

FIG. 3 is a sectional view of a window assembly 66a, in accordance with an embodiment of the present invention. Window assembly 66a may replace, for example, window assembly 66 of FIGS. 1 and 2 above.

In some embodiments, X-ray enclosure 55 has a window 65a, which is optically transparent and is configured to: (i) pass laser beam 33 into X-ray enclosure 55, and to absorb, and thereby, (ii) prevent emission of X-ray beams 12, 16 and 20 (shown in FIGS. 1 and 2 above) from exiting X-ray enclosure 55.

In some embodiments, window assembly 66a comprises a sealing material 67, which is disposed within window 65a, and is configured to: (i) seal window 65a to retain the low level of vacuum (e.g., a pressure equal to or larger than about 10^{-'}torr) within X-ray enclosure 55, (ii) pass laser beam 33, and (iii) block X-ray beams 12, 16 and 20 from exiting through window 65a. In the example of FIG. 3, sealing material 67 comprises a dense flint glass such as ZF7 glass which contains lead (e.g., whose mass density is about 5 grams per cubic centimeter and so does have the property of being both optically transparent and X-ray absorbing. However, the glass tends to go brown over time due to the formation of color centers by exposure to the ionizing X-rays and this causes the optical transmission to fall over time. The ZF7 glass is supplied, for example, by CDGM engineering (Canonsburg, Pennsylvania).

In some embodiments, sealing material 67 is further configured for preventing the entrance of atmospheric air into X-ray enclosure 55.

In other embodiments, X-ray enclosure 55 is configured to operate at atmospheric pressure, so that, instead of sealing material 67, window 65a may be filled with any suitable material (e.g., the aforementioned ZF7 glass) configured to (i) pass laser beam 33 into X-ray enclosure 65, and (ii) block X-ray beams 12, 16 and 20 from exiting through window 65a.

FIG. 4 is a sectional view of a window assembly 66b, in accordance with an embodiment of the present invention. Window assembly 66b may replace, for example, window assembly 66 of FIGS. 1 and 2 above.

In some embodiments, in the example of FIG. 4, X-ray enclosure 55 is configured to operate at atmospheric pressure. In such embodiments, instead of the sealed window 65a of FIG. 3 above, X-ray enclosure 55 has an opening 36 that may remain open, or alternatively, be filled with any material transparent to laser beam 33. In this configuration, opening 36 may replace, for example, window 65 of FIGS. 1 and 2 above.

In some embodiments, window assembly 66b comprises a labyrinth 77, which is configured to absorb any X-ray radiation (e.g., any of X-ray beams 12, 16 and 20) that passes through the window (e.g., opening 36) of X-ray enclosure 55, and at the same time not to obstruct the path of laser beam 33.

In some embodiments, labyrinth 77 has an opening 34, and a compartment 35 defined by walls made of X-ray opaque (or partially opaque) material. Moreover, compartment 35 is configured to encompass (and contain) at least one prism 32 configured to refract laser beam 33. In the example of FIG. 4, laser beam 33 enters compartment 35 through opening 34, and subsequently, being refracted by prism 32 and directed to exit compartment 35 through opening 36 into X-ray enclosure 55. It is noted that the value of the refractive index of X-rays is close to 1, whereas in the present example, the value of the refractive index of laser beam is between about 1.5 and 2.0. Thus, labyrinth 77 is configured to bend and pass laser beam 33 into X-ray enclosure 55, whereas the walls of compartment 35 of labyrinth 77 are configured to absorb the X-ray radiation (e.g., any of X-ray beams 12, 16 and 20) that pass-through opening 36.

In other words, window assembly 66b is coupled to opening 36 that serves as window 65 of FIGS. 1 and 2 above. In the example of FIG. 4 window assembly 66b is configured to: (i) bend and pass the laser beam 33 into the X-ray enclosure 55, and (ii) block the emission of the one or more X-ray beams 12, 16 and 20 from exiting X-ray enclosure 55.

In other embodiments, labyrinth 77 may comprise one or more optical elements, in the present example, one or more additional reflecting and/or refracting elements configured to bend laser beam 33. For example, labyrinth 77 may comprise two compartments: (i) a first compartment having a mirror, or an additional prism configured to reflect or refract laser beam 33, (ii) a second compartment comprising prism 32, and an opening between he first and second compartments. One example implementation of a multi-compartment labyrinth is shown and depicted in detail in FIG. 6 below.

In other embodiments, at least one of openings 34 and 36 may be sealed with any suitable material disposed therein, such as sealing material 67 of FIG. 3 above. In such embodiments, sealing material 67 is configured to: (i) seal at least one of openings 34 and 36 to retain the low level of vacuum (e.g., a pressure equal to or larger than about 10⁻³ torr) within X-ray enclosure 55, and (ii) pass laser beam 33. Moreover, as described in FIG. 3 above, sealing material 67 is configured to block (or at least partially block) X-ray beams 12, 16 and 20 from exiting through the respective opening, e.g., opening 34. It is noted, however, that the walls of labyrinth 77 are configured to absorb any X-ray radiation and prevent the X-ray radiation from exiting X-ray enclosure 55. As such, in order to maintain the level of vacuum in X-ray enclosure 55, any vacuum sealing material that is transparent to laser beam 33 may be disposed into one or both of openings 34 and 36, even if this material is not adapted to passage of block X-ray radiation.

FIG. 5 is a sectional view of a window assembly 66c, in accordance with an embodiment of the present invention. Window assembly 66c may replace, for example, window assembly 66 of FIGS. 1 and 2 above.

In some embodiments, window assembly 66c comprises a labyrinth 88 having compartment 35 encompassing a mirror 41 instead of prism 32 shown in FIG. 4 above. In this configuration, labyrinth 88 is configured to absorb any of the X-ray radiation (e.g., any of X-ray beams 12, 16 and 20) that may pass through opening 36 of X-ray enclosure 55, and at the same time not to obstruct the path of laser beam 33.

In the example of FIG. 5, laser beam 33 enters compartment 35 through opening 34, and subsequently, being reflected by mirror 41 and directed to exit compartment 35 through opening 36 into X-ray enclosure 55.

In some embodiments, prism 32 of FIG. 4 and mirror 41 of FIG. 5 comprise any suitable prism and mirror configured to steep laser beam 33. Such laser reflecting and/or refracting components are supplied, for example, by Thor Labs (Newton, New Jersey 07860), Edmund Optics (101 East Gloucester Pike Barrington, New Jersey), and Newport Corporation (1791 Deere Avenue Irvine, CA 92606).

FIG. 6 is a sectional view of a window assembly 66d, in accordance with an embodiment of the present invention. Window assembly 66d may replace, for example, window assembly 66 of FIGS. 1 and 2 above.

In some embodiments, window assembly 66d comprises a labyrinth 99 having walls that are opaque (or partially opaque) to X-rays and define compartments 37 and 39 encompassing mirrors 42 and 43, respectively. Labyrinth 99 has openings 38 and 36 in compartments 37 and 39, respectively. Opening 36 is located between X-ray enclosure 55 and compartment 39. Moreover, labyrinth 99 has a wall 45 configured to separate between compartments 37 and 39, and an opening 40 through which laser beam 33 passes between compartments 37 and 39.

In the example of FIG. 6, laser beam 33 enters compartment 37 through opening 38, and subsequently, being reflected by mirror 42 and directed to pass through opening 40 into compartment 39. Subsequently, laser beam 33 impinges on the surface of mirror 43 and being reflected to exit compartment 39 through opening 36 into X-ray enclosure 55.

In this configuration, labyrinth 99 is configured to absorb any of the X-ray radiation (e.g., any of X-ray beams 12, 16 and 20) that may pass through opening 36, and at the same time not to obstruct the path of laser beam 33. It is noted that by having two compartments, any X-ray radiation that may pass through opening 36 impinges on more X-ray absorbing walls (e.g., compared to labyrinths 66b and 66c of FIGS. 4 and 5 above), and therefore, increase the absorption of this X-ray radiation, and prevents any emission of X-ray radiation out of labyrinth 99.

In other embodiments, at least one of mirrors 42 and 43 may be replaced by another reflecting or refracting element. For example, mirror 43 may be replaced by a prism such as prism 32 of FIG. 4 above.

In alternative embodiments, labyrinth 99 may comprise more than two compartments encompassing more reflecting and/or refracting elements for bending and steering laser beam 33. In the example of FIGS. 4-6 laser beam 33 is steered in about 90°. In other embodiments, labyrinth 99 may comprise any suitable combination of reflecting or refracting elements positioned within compartments 37 and 39 to steer laser beam 33 using any suitable steering angles other than about 90°.

In other embodiments, at least one of openings 38, 40 and 36 may be sealed with any suitable material disposed therein, such as sealing material 67 of FIG. 3 above. In such embodiments, sealing material 67 is configured to: (i) seal at least one of openings 38, 40 and 36 to retain the low level of vacuum (e.g., a pressure equal to or larger than about 10⁻³ torr) within X-ray enclosure 55, and (ii) pass laser beam 33. Moreover, as described in FIG. 3 above, sealing material 67 may comprise the ZF7 glass configured to block X-ray beams 12, 16 and 20 from exiting through opening 36.

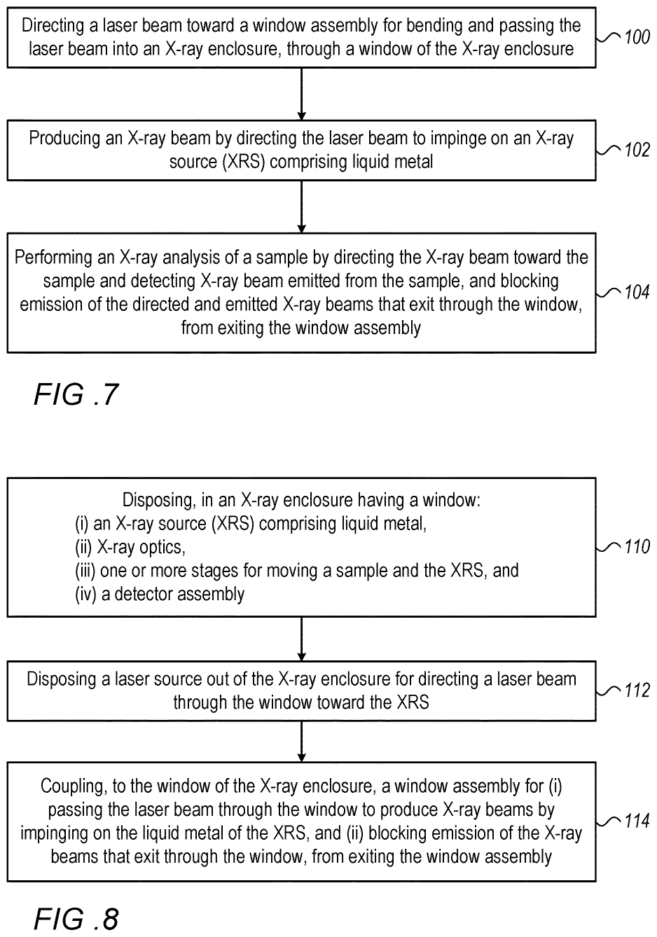

FIG. 7 is a flow chart that schematically illustrates a method for operating X-ray analysis systems 10 and 11 using at least one of windows assemblies 66b-66d of FIGS. 4-6 above, respectively, in accordance with an embodiment of the present invention.

The method begins at a laser beam directing step 100, with directing laser beam 33 toward window assembly 66 for bending and passing laser beam 33, through window 65, into X-ray enclosure 55, as described in detail in FIGS. 1-6 above.

At an X-ray beam producing step 102, one or more X-ray beams 12 are produced by directing laser beam 33 to imping on the liquid metal target of XRS, as described in detail in FIG. 1 above.

At an X-ray analysis step 104 that concludes the method, processor 50 performs X-ray analysis at one or more measurement sites in sample 18 by directing X-ray beam 33 toward sample 18 (either in reflecting or transmission geometry), and detecting X-ray beam 20 scattered from sample 18, and blocking emission of any of X-ray beams 12, 16 and 20 that may exit through window 65, from exiting window assembly 66, as described in detail in FIGS. 3-6 above. It is noted that in the configuration of FIGS. 4-6 window assemblies 66b, 66c, and 66d are configured to bend and pass laser beam 33 into X-ray enclosure 55, and in the configuration of FIG. 3, window assembly 66a is configured to pass laser beam 33, without bending or steering laser beam 33, through window 65a and sealing material 67 into X-ray enclosure 55.

FIG. 8 is a flow chart that schematically illustrates a method for producing X-ray analysis systems 10 and 11, in accordance with an embodiment of the present invention.

The method begins at an X-ray components and assemblies disposing step 110 with disposing, in X-ray enclosure 55 having window 65: (i) XRS 44 comprising the liquid metal target, (ii) X-ray optics 14 and 24, (iii) stages 19 and 21 for moving sample 18 and XRS 44, respectively, and (iv) detector assembly 26, as described in detail in FIGS. 1 and 2 above.

In some embodiments, the X-ray components and assemblies may be arranged in a reflection geometry shown and described in FIG. 1 above. In other embodiments, the X-ray components and assemblies may be arranged in a transmission geometry shown and described in FIG. 2 above.

At a laser disposing step 112, laser source 22 is disposed out of X-ray enclosure 55 for directing laser beam 33 through window 65 toward XRS 44, as described in detail in FIG. 1 above.

At a window assembly coupling step 114 that concludes the method, window assembly 66 is coupled to window 65 of X-ray enclosure 55 for: (i) passing laser beam 33 through window 65 to produce X-ray beams 12 by impinging on the liquid metal of XRS 44, and (ii) blocking emission of any of X-ray beams 12, 16 and 20 that may exit through window 65, from exiting window assembly 66, as described in detail in FIGS. 3-6 above.

In some embodiments, window assembly 66 is assembled to X-ray enclosure 55 using any suitable assembling technique (e.g., gluing or using suitable screws).

In other embodiments, window assembly 66 may be produced together with X-ray enclosure 55, as one part or as pre-connected parts.

These particular steps of the methods of FIGS. 7 and 8 are simplified and presented by way of example, in order to illustrate certain problems that are addressed by embodiments of the present invention and to demonstrate the application of these embodiments in enhancing the performance of operating and producing/assembling such X-ray analysis systems. Embodiments of the present invention, however, are by no means limited to these specific methods and steps, and the principles described herein may similarly be applied to operating and producing other sorts of X-ray analysis systems.

In some embodiments, the method of FIG. 8 may comprise additional steps, such as but not limited to integrating beam monitor 17, processor 50 and other components and assemblies suitable for such X-ray analysis systems. Moreover, the method of FIG. 7 may comprise additional steps, such as but not limited to controlling the generation of laser beam 33 and X-ray beams 12, and directing X-ray beams 16 and 20 toward sample 18 and detector assembly 26 to carry out the X-ray analysis at selected sites of sample 18, as described in detail in FIG. 1 above.

Although the embodiments described herein mainly address X-ray analysis systems having liquid metal-based targets, the methods and systems described herein can also be used in other applications, such as in X-ray analysis systems having any other suitable type of X-ray targets, for example, a continuous metal wire having a diameter between about a few micrometers (μm) (e.g., less than about 10 μm) and about 1000 μm, or a metal strip having a surface on which the laser beams impinge (e.g., in the YZ plane) between about 1 μm and 1000 μm in dimensions along the YZ plane. It is noted that the liquid-metal based target may comprise droplets of liquid metal or a continuous jet of liquid metal.

Moreover, the disclosed techniques may be used in a broad range of X-ray analysis techniques and applications, such as but not limited to: (i) X-ray reflectivity (XRR) for analyzing thin films, (ii) X-ray diffraction (XRD) for analyzing polycrystalline materials, (iii) High resolution XRD for analyzing epitaxial films and single crystal substrates, (iv) X-ray fluorescence (XRF) for analyzing both thin and thick films and various types of structures, (v) X-ray topography for imaging and analyzing single crystal defects, (vi) Single crystal XRD for chemical analysis and biological crystallography, (vii) reflection and transmission Critical-Dimension Small-Angle X-ray Scattering (CD-SAXS) and/or (viii) low energy X-ray scattering metrology at higher angles for critical dimensions (XCD) for analyzing shape and orientation of periodic arrays of nanostructures. These techniques and applications may be applied in stand-alone usage or in combination with results from other techniques for hybrid analysis.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system for X-ray analysis, the system comprising:
an X-ray enclosure, which is configured to (a) contain an X-ray source (XRS) configured to emit one or more X-ray beams in response to a laser beam impinging on a surface of the XRS, and (b) prevent emission of the one or more X-ray beams from exiting the X-ray enclosure, the X-ray enclosure having a window configured to pass the laser beam into the X-ray enclosure; and
a window assembly, which is coupled to the window, the window assembly is configured to: (i) bend and pass the laser beam into the X-ray enclosure, and (ii) block the emission of the one or more X-ray beams from exiting the X-ray enclosure.

2. The system according to claim 1, wherein the window assembly comprises (i) an X-ray blocking labyrinth, and (ii) one or more mirrors positioned in the labyrinth and configured to bend the laser beam one or more times, respectively.

3. The system according to claim 1, wherein the window assembly comprises (i) an X-ray blocking labyrinth, and (ii) one or more prisms positioned in the labyrinth and configured to bend the laser beam one or more times, respectively.

4. The system according to claim 1, wherein the X-ray enclosure is configured to operate at a pressure larger than 10⁻³ torr.

5. The system according to claim 1, wherein the X-ray enclosure is configured to operate at an atmospheric pressure.

6. The system according to claim 1, wherein the XRS comprises liquid metal, and wherein the one or more X-ray beams are emitted in response to the laser beam impinging on the liquid metal.

7. The system according to claim 1, wherein the XRS comprises a target selected from a list of targets constituting at least one of (i) a continuous solid metal wire, (ii) a strip of solid metal, (iii) droplets of liquid metal, (iv) a jet of continuous liquid metal, (v) a rotating drum coated with liquid metal, and (vi) a rotating disk coated with liquid metal, and wherein the one or more X-ray beams are emitted in response to the laser beam impinging on the target.

8. The system according to claim 1, wherein the laser beam is generated by a laser source positioned out of the X-ray enclosure.

9. The system according to claim 1, wherein the one or more X-ray beams comprise pulses of X-ray beams.

10. The system according to claim 9, wherein the pulses of X-ray beams have a frequency between 1 KHz and 100 MHz's.

11. A method, comprising,
receiving a laser beam directed toward a window of an X-ray enclosure;
bending the laser beam in a window assembly coupled to the window, and directing the laser beam through the window toward an X-ray source (XRS) disposed within the X-ray enclosure;
emitting one or more X-ray beams by impinging the laser beam on the XRS; and
blocking the emission of the one or more X-ray beams from exiting the X-ray enclosure.

12. The method according to claim 11, wherein the window assembly has (i) an X-ray blocking labyrinth, and (ii) one or more mirrors positioned in the labyrinth, and wherein bending the laser beam in the window assembly and directing the laser beam comprises passing the laser beam between the one or more mirrors for bending the laser beam one or more times, respectively, and directing the laser beam through the window toward the XRS.

13. The method according to claim 11, wherein the window assembly has (i) an X-ray blocking labyrinth, and (ii) one or more prisms positioned in the labyrinth, and wherein bending the laser beam in the window assembly and directing the laser beam comprises passing the laser beam between the one or more mirrors for bending the laser beam one or more times, respectively, and directing the laser beam through the window toward the XRS.

14. The method according to claim 11, and comprising operating the X-ray enclosure at a pressure larger than 10⁻³ torr.

15. The method according to claim 11, and comprising operating the X-ray enclosure at an atmospheric pressure.

16. The method according to claim 11, wherein the XRS comprises liquid metal, and wherein emitting the one or more X-ray beams comprises directing the laser beam toward the liquid metal and emitting the one or more X-ray beams by impinging the laser beam on the liquid metal.

17. The method according to claim 11, wherein receiving the laser beam comprises generating the laser beam in a laser source positioned out of the X-ray enclosure, and directing the laser beam toward the window, and wherein emitting the one or more X-ray beams comprises emitting pulses of the one or more X-ray beams.

18. A method for producing an X-ray analysis system, the method comprising:
disposing, in an X-ray enclosure having a window, (i) an X-ray source (XRS) for generating one or more x-ray beams, (ii) a detector assembly for generating a signal in response to the one or more X-ray beams impinging on a sample and subsequently impinging on the detector assembly, and (iii) X-ray optics for directing the one or more X-ray beams (a) from the XRS toward the sample, and (b) from the sample toward the detector assembly;
disposing a laser source out of the X-ray enclosure for directing a laser beam through the window toward the XRS; and
coupling, to the window of the X-ray enclosure, a window assembly having (i) an X-ray blocking labyrinth, and (ii) one or more optical elements positioned in the labyrinth for (a) bending the laser beam one or more times within the X-ray blocking labyrinth, respectively, and (b) directing the laser beam through the window toward the XRS for generating the one or more X-ray beams.

19. The method according to claim 18, wherein the one or more optical elements for bending and directing the laser beam comprises at least one of: (i) a mirror for reflecting the laser beam, and (ii) a prism for refracting the laser beam.

20. The method according to claim 18, wherein the X-ray enclosure is opaque to the one or more X-ray beams, and the window is for passing the laser beam into the X-ray enclosure.

21-22. (canceled)
